(19) United States
(12) Patent Application Publication
(10) Pub. No.: US 2009/0210464 A1
(43) Pub. Date: Aug. 20, 2009

(54) STORAGE MANAGEMENT SYSTEM AND METHOD THEREOF

(75) Inventor: YI-TA CHIANG-LIN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/257,359

(22) Filed: Oct. 23, 2008

(30) Foreign Application Priority Data
Feb. 18, 2008 (CN) 200810300352.3

(51) Int. Cl. G06F 12/02; G06F 17/30

(52) U.S. Cl. 707/205; 711/171; 711/173; 711/E12.002; 707/E17.01; 707/E17.044

(57) ABSTRACT

A storage management system includes a storage unit with first and second partitions with consecutive physical addresses. The control unit manages the storage unit and has a measurement unit, arrangement unit, and reallocation unit. The arrangement unit arranges currently stored files in the two partitions. The measurement unit measures the file, the free space of the two partitions, a difference between the file size and the free space of the second partition, and determines whether the free space of the second partition is sufficient to store the file. The reallocation unit shares the free space from the first partition to the second partition.

### BACKGROUND

1. Field of Invention

The disclosure relates to storage management and, particularly, to a storage management system for automatically adjusting partition space and method thereof.

2. Description of the Related Art

Generally, a storage device is partitioned into fixed partitions to group directions and files by categories, and a storage management system is installed in one of the partitions (typically the master partition) for managing the partitions. However, a partition for storage of a dedicated data type or group may become full, making it impossible to store new files or directories intended for being stored therein.

Therefore, it is desirable to provide a storage management system, which can overcome the limitations described.

### BRIEF DESCRIPTION OF THE DRAWINGS

FIG. 1 is a block diagram of a storage management system according to an exemplary embodiment.

FIG. 2 is a schematic, block diagram of a storage unit of the storage management system of FIG. 1 according to an exemplary embodiment.

FIGS. 3A and 3B are a flowchart of a storage management method for automatically adjusting partition space when new files are added, according to an exemplary embodiment.

FIG. 4 is a flowchart of a partition space recovery process of the storage management system when a file is deleted from a partition, according to an exemplary embodiment.

### DETAILED DESCRIPTION OF EMBODIMENTS

Embodiments of the present storage management system and storage management method will be described in detail below with reference to the drawings.

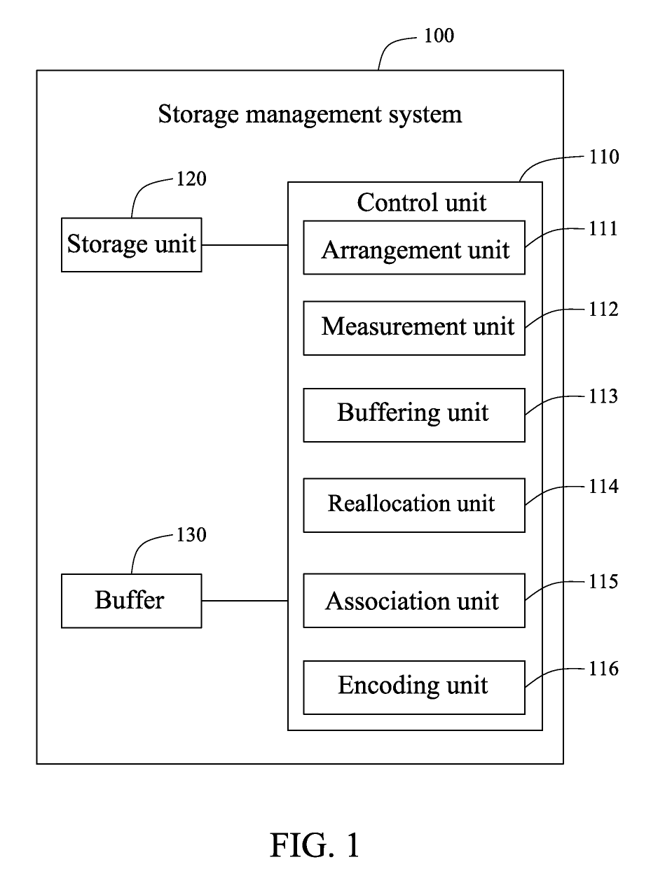

Referring to FIG. 1, a storage management system 100 includes a control unit 110, a storage unit 120, and a buffer 130. The storage management system 100 can be applied to a computer, wherein, accordingly, the storage unit 120 is a main storage facility of the computer such as a hard disk. Alternatively, the storage management system 100 can be applied to a portable electronic device, wherein the storage unit 120 can be a volatile memory thereof.

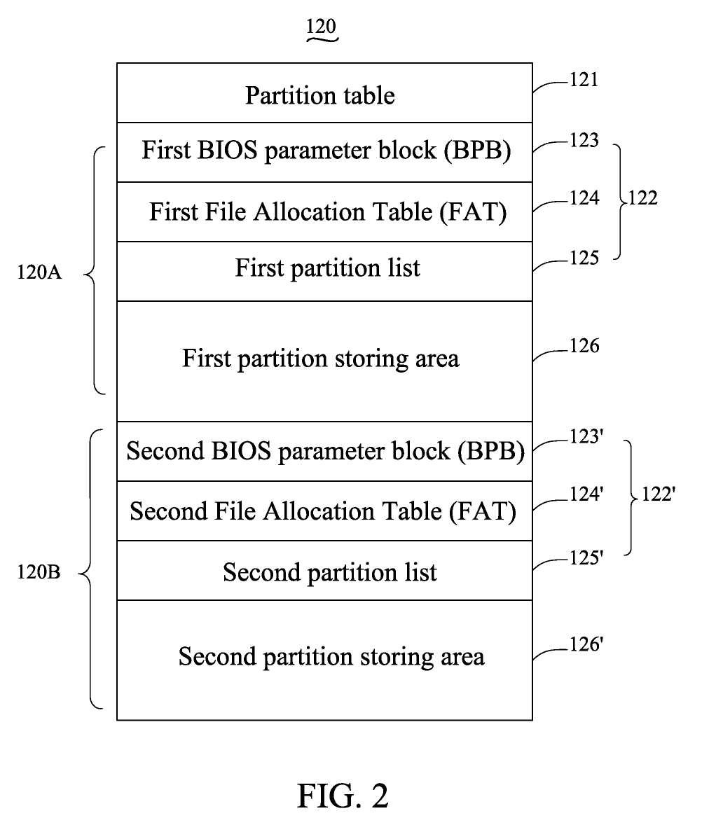

Referring to FIG. 2, the storage unit 120 is divided into a number of partitions suitable for storage of dedicated files. In this example, the storage unit 120 is divided into a first partition 120A and a second partition 120B, with the physical address of the second partition 120B sequential to that of the first partition 120A, and includes a partition table 121 containing partition information such as the number, size, and physical addresses of the partitions. The first partition 120A includes a first partition information table 122 that contains a first partition BIOS parameter block (BPB) 123, a first partition File Allocation Table (FAT) 124 and a first partition list 125, and a first partition storage area 126. The second partition 120B includes a second partition information table 122′ that contains a second BPB 123′, a second partition FAT 124′ and a second partition list 125′, and a second partition storage area 126′. The first partition BPB 123 records the size of the first partition 120A. The first partition FAT 124 records the physical and corresponding logical addresses of files currently stored in first partition storage area 126. The first partition list 125 keeps recorded information of the currently stored files. The second partition BPB 123′ records the size of the second partition 120B. The second partition FAT 124′ records the physical and corresponding logical addresses of files currently stored in second partition storage area 126′. The second partition list 125′ keeps recorded information of the currently stored files.

To conserve storage space, during partitioning, the second partition 120B is allocated relatively less space than first partition 120A. The first partition 120A is automatically adjusted during storage of new files larger than available space on the second partition 120B.

Referring back to FIG. 1, the control unit 110 includes an arrangement unit 111, a measurement unit 112, a buffering unit 113, a reallocation unit 114, an association unit 115, and an encoding unit 116.

The arrangement unit 111 is configured for arranging files currently stored in the first and second partition storage areas 126, 126′, allocating consecutive logical addresses of the currently stored files, and sharing a part of the free space of the first partition storage area 126 with the second partition storage area 126′ accordingly. The consecutive logical addresses are allocated for reallocation of the first partition 120A and the second partition 120B.

The measurement unit 112 measures the free space (N) of a partition, for example, the second partition storage area 126′, and the size of a new file (M) to be stored, acquiring a difference (P) (P=M−N) and determining whether the free space (N) of the measured partition is sufficient to store the file (M). If not, the measurement unit 112 measures the free space (Q) of the other partition, here, the first partition storage area 126, to determine whether the free space (Q) is larger than the difference (P), and, if so, the reallocation unit 114 is activated, and if not, operations are suspended and an error message, such as “insufficient space,” is issued.

The buffering unit 113 temporarily stores logical addresses of currently stored files according to the first and second FATs 124, 124′ into the buffer 130.

The reallocation unit 114 is configured for altering the first and second partition information tables 122, 122′ respectively according to changes made to the first and second partition storage areas 126, 126′ and updating the first and second partition information tables 122, 122′ after the new file has been stored. For example, according to the difference (P) measured from the measurement unit 112, the reallocation unit 114 allocates a part of the free space (Q) of the first partition storage area 126 to the second partition storage area 126′ for storing the new file (M). The reallocated second partition storage area 126′ has additional free space in the amount of the difference (P) more than the original second partition storage area 126′.

The association unit 115 is configured for establishing an association between physical addresses and logical addresses of the stored files according to the updated first and second partition information tables 112, 112′ to rapidly access the stored files. In this embodiment, the association unit 15 can generate a table containing physical addresses and corresponding addresses of the stored files.

The encoding unit 116 is configured to set a password to encode the stored files of the second partition storage area 126′ for authorized access to the files.

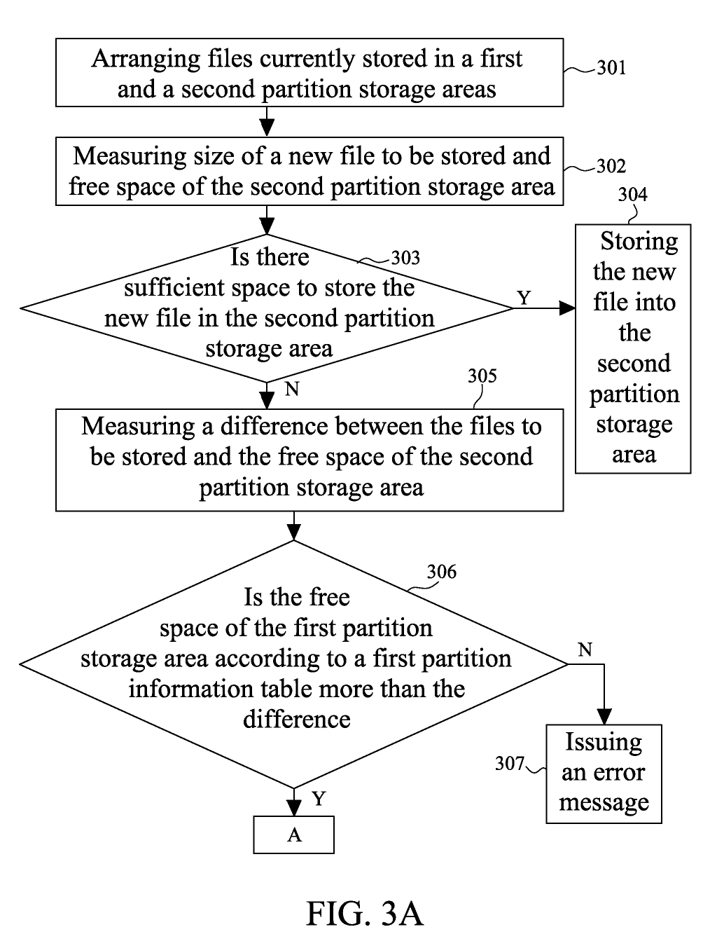

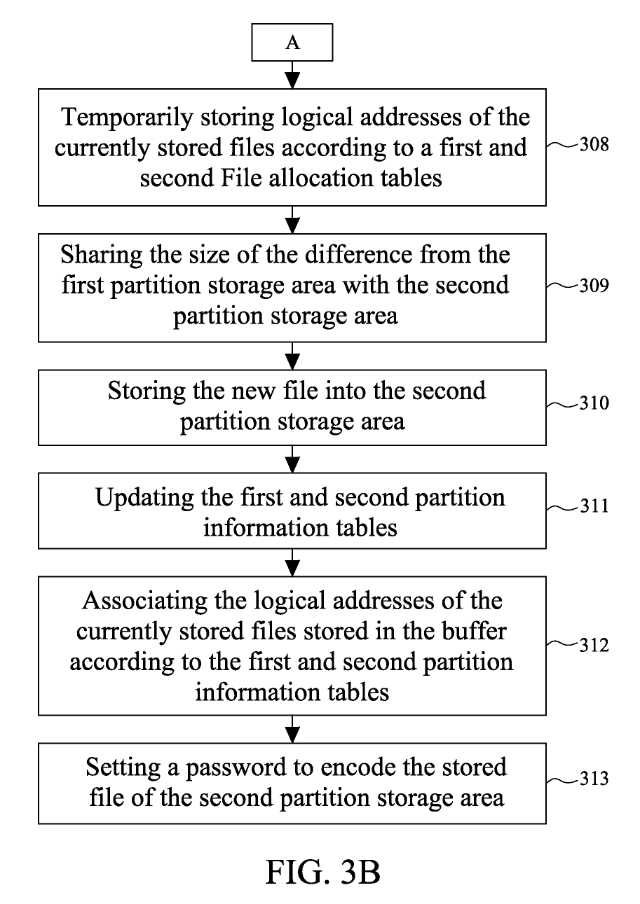

Referring to FIGS. 3A and 3B, a method of the storage management for automatically adjusting partition space includes steps 301 through 313.

In step 301, files currently stored in the first and second partition storage areas 126, 126′ are arranged in order to allocate consecutive logical addresses of the files to share a part of first partition storage area 126 with the second partition storage area 126′. In this embodiment, the files are arranged by the arrangement unit 111.

In step 302, the size of a new file to be stored (M) and free space of the second partition storage area 126′ (N) are measured.

In step 303, it is determined whether the free space (N) of the second partition storage area 126′ is sufficient to store the new file (M), and, if so, step 304 is executed, and, if not, step 305 is executed.

In step 304, the new file (M) is stored into the second partition storage area 126′.

In step 305, a difference between the file (M) to be stored and the free space (N) of the second partition storage area 126′ is measured. In this embodiment, the difference (P) is measured (P=M−N).

In step 306, it is determined whether the free space of the first partition storage area 126, measured as Q according to the first partition information table 122, exceeds the difference (P). If not, step 307 is executed, and if so, step 308 is executed.

In step 307, if the free space (Q) of the first partition storage area 126 is less than or equal to the difference (P), an error message, such as “sufficient space” is issued.

In step 308, if the free space (Q) of the first partition storage area 126 exceeds the difference (P), logical addresses of the currently stored files are temporarily stored according to the first and second FATs 124, 124′. In this embodiment, the logical addresses are temporarily stored in the buffer 130.

In step 309, the size of the difference (P) from the first partition storage area 126 is shared to the second partition storage area 126′ for reallocation of the first and second partitions 126, 126′. In this embodiment, the second partition storage area 126′ is reallocated to increase the size of the difference (P) from the first partition storage area 126.

In step 310, the files (M) are stored into the second partition storage area 126′.

In step 311, the first and second partition information tables 122, 122′ are updated.

In step 312, the logical addresses of the currently stored files temporarily stored in the buffer 130 are associated according to the first and second partition information tables 122, 122′. The logical address according to the corresponding physical address of the file is associated.

In step 313, a password is set to encode the stored file of the second partition storage area 126′ for authorized access to the file.

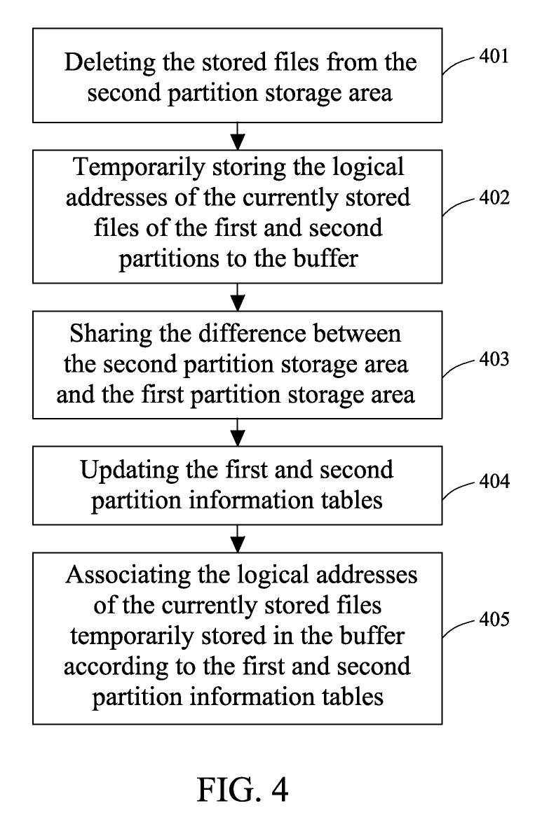

Referring to FIG. 4, a partition space recovery process of the storage management system 100 when a file is deleted from a partition, according to an exemplary embodiment, includes steps 401˜405.

In step 401, a stored file is deleted from the second partition storage area 126′.

In step 402, the logical addresses of the currently stored files of the first and second partition storage areas 126, 126′ are temporarily stored to the buffer 130.

In step 403, the difference (P) of the second partition storage area 126′ is shared to the first partition storage area 126 for recovery.

In step 404, the first and second partition information tables 122, 122′ are updated.

In step 405, the logical addresses of the currently stored files temporarily stored in the buffer 130 are associated according to the first and second partition information tables 122, 122′. The logical addresses according to the corresponding physical addresses of the currently stored files are associated.

The storage management system of the disclosure adjusts partitions automatically, with the files securely stored into the second partition storage area with password-protection encoding.

The storage management system can repartition appropriate partitions automatically according to the size of the added file and of deleted files, increasing utilization of the partitions efficiently.

It will be understood that the above particular embodiments are described and shown in the drawings by way of illustration only. The principles and features of the disclosure may be employed in various and numerous embodiments thereof without departing from the scope of the invention as claimed. The above-described embodiments illustrate the scope of the invention but do not restrict the scope of the invention.

What is claimed is:

1. A storage management system, comprising:
a storage unit having a first partition and a second partition with consecutive physical addresses and configured for storing a new file; and
a control unit configured for managing the storage unit and comprising:
a measurement unit configured for measuring size of the new file to be stored and free space of the first and the second partitions respectively, a difference between the new file and the free space of the second partition, and determining whether the free space of the second partition is sufficient to store the new file;
an arrangement unit configured for arranging currently stored files in the first and second partitions; and
a reallocation unit configured for sharing the free space of the first partition with the second partition to store the file.

2. The storage management system of claim 1, wherein the storage unit further comprises a partition table recording the number, sizes, and physical addresses of the currently stored files in the partitions.

3. The storage management system of claim 1, wherein the first partition comprises a parameter block, a file allocation table, a partition list, and a storage area, and the second partition comprises a parameter block, a file allocation table, a partition list, and a storage area.

4. The storage management system of claim 3, wherein a first partition information table comprises the parameter block, the file allocation table, the partition list, and the second partition information table comprises the parameter block, the file allocation table, the partition list.

5. The storage management system of claim 4, further comprising a buffer configured for temporarily storing logical addresses of the first and second partitions according to the first and the second partition information tables; the control unit further comprising a buffering unit configured for utilizing the buffer.

6. The storage management system of claim 5, wherein the control unit further comprises an association unit configured for establishing an association between the physical addresses and the logical addresses of the stored files according to the first and second partition information tables.

7. The storage management system of claim 1, wherein the control unit further comprises an encoding unit configured for setting a password to encode the new file of the second partition.

8. A method of storage management, wherein a storage unit is provided and comprises a first partition and a second partition with consecutive physical addresses, the method comprising:
arranging files currently stored in the first partition and the second partition;
measuring a size of a new file to be stored and free space of the second partition;
determining whether the free space of the second partition is sufficient to store the new file;
if not, measuring a difference between the free space of the second partition and the size of the file;
measuring free space of the first partition to determine whether the free space of the first partition exceeds the difference;
if so, sharing a size of the difference from the first partition with the second partition; and
storing the file into the second partition.

9. The method of claim 8, further comprising a step of storing the file to the storage unit if the free space of the second partition exceeds the size of the file to be stored.

10. The method of claim 8, further comprising a step of issuing an error message if the free space of the first partition is less than the difference between the free space of the second partition and the size of the file to be stored.

11. The method of claim 8, wherein the first partition comprises a first partition information table, and the second partition comprises a second partition information table.

12. The method of claim 11, further comprising a step of updating the first and the second partition information tables after storage of the new file.

13. The method of claim 12, further comprising a step of temporarily storing logical addresses of the currently stored files in a buffer after update of the first and second partition information tables.

14. The method of claim 13, further comprising a step of establishing an association between the physical addresses and the logical addresses of the stored files according to the first and second partition information tables.

15. The method of claim 14, further comprising setting a password to encode the new file in the second partition after association.

16. The method of claim 8, further comprising, if the stored file is deleted from the second partition;
temporarily storing logical addresses of the currently stored file in the buffer; and
sharing the difference from the second partition with the first partition.

17. The method of claim 16, further comprising a step of updating the first and the second partition information tables after share.

18. The method of claim 17, further comprising a step of associating the logical addresses of the currently stored files according to the first and second partition information tables after update.
